(19) United States
(12) Patent Application Publication
(10) Pub. No.: US 2014/0159633 A1
(43) Pub. Date: Jun. 12, 2014

(54) MOTOR CONTROL APPARATUS AND METHOD

(71) Applicant: SAMSUNG ELECTRO-MECHANICS CO., LTD.,, Suwon (KR)

(72) Inventor: Bon Young GU, Suwon (KR)

(73) Assignee: SAMSUNG ELECTRO-MECHANICS CO., LTD.,, Suwon (KR)

(21) Appl. No.: 13/794,176

(22) Filed: Mar. 11, 2013

(30) Foreign Application Priority Data
Dec. 6, 2012 (KR) 10-2012-0141451

(51) Int. Cl. H02K 11/00; H02P 29/00

(52) U.S. Cl. CPC H02K 11/0015; H02P 29/00
USPC 318/461; 318/490

(57) ABSTRACT

There are provided a motor control apparatus and method. The motor control apparatus includes: a signal generating unit generating a first signal; a sampling unit obtaining the numbers of pulses of the first signal included in a plurality of sampling sections having different start timings, respectively; and a calculating unit calculating a speed of a motor using the numbers of pulses of the first signal obtained with respect to the plurality of sampling sections.

### CROSS-REFERENCE TO RELATED APPLICATIONS

This application claims the priority of Korean Patent Application No. 10-2012-0141451 filed on Dec. 6, 2012, in the Korean Intellectual Property Office, the disclosure of which is incorporated herein by reference.

### BACKGROUND OF THE INVENTION

1. Field of the Invention

The present invention relates to a motor control apparatus and method capable of detecting a first signal indicating a speed of a motor and obtaining the number of pulses of the first signal included in a predetermined sampling section, in detecting the speed of the motor, and more particularly, to a motor control apparatus and method capable of accurately detecting a speed of a motor without significantly increasing a period of a sampling section by obtaining the numbers of pulses of a first signal included in a plurality of sampling sections having different start timings, respectively, and calculating the speed of the motor using the obtained numbers of pulses.

2. Description of the Related Art

When a motor is operated, an output signal of a sensor detecting a position, a speed, and the like, of a rotor may be generated in pulse form. The sensor signal generated in pulse form is used to detect the speed of the motor, the position of the rotor within the motor, and the like, and operate the motor at a desired speed, whereby the motor may be controlled appropriately. Therefore, in order to precisely control the motor as desired, the speed, position, and the like, of the motor, should be precisely detected.

In the case in which the number of pulses included in the sensor signal during a single rotation of the rotor in the motor is defined as pulses per rotation (PPR), revolutions per minute (RPM) of the motor may be defined as follows.

Revolutions per minute (RPM) of Motor=(60/Tc)(n/PPR) [Equation 1]

In Equation 1, Tc refers to a sampling period in which the number of pulses included in the sensor signal is detected, and n refers to the number of pulses included in a single sampling period.

When the number of pulses included in a predetermined sampling period is detected, since the sampling period and the pulses are in a state in which they are not synchronized with each other, an error may occur in determining the number of pulses. In particular, in the case of n=1 in the above Equation 1, the largest error occurs in the revolutions per minute (RPM) of the motor. By increasing PPR, simply, by increasing Tc, the error in the revolutions per minute (RPM) of the motor may be decreased. However, when Tc is increased, a sampling period in which the number of pulses is detected is increased, and even pluses generated before a point in time in which the speed of the motor is to be detected have an effect on calculating the speed of the motor. Therefore, there may be a problem in that Tc may not be infinitely increased in order to decrease an error rate in the revolutions per minute (RPM) of the motor.

Related Art Document 1, which relates to a control apparatus for a vehicle and a signal sampling method, discloses a feature of adjusting a sampling period and detecting a varied speed from the adjusted sampling period. Related Art Document 2, which relates to a speed detecting apparatus of a servo motor, discloses a feature of dividing a sampling period and detecting a speed of a motor based on the division result. However, neither of Related Art Documents 1 and 2 disclose a feature of detecting the numbers of pulses in a plurality of sampling sections having different start timings and calculating a speed of a motor based on the numbers of pulses detected as described above.

### RELATED ART DOCUMENT

(Patent Document 1) Japanese Patent Laid-Open Publication No. 2010-076536
(Patent Document 2) Japanese Patent Laid-Open Publication No. 1993-188066

### SUMMARY OF THE INVENTION

An aspect of the present invention provides a motor control apparatus and method capable of accurately detecting a speed of a motor, without significantly increasing a period of a sampling section, and precisely controlling the speed of the motor therefrom by generating a first signal including a plurality of pulses from the motor, calculating the numbers of pulses of the first signal included in a plurality of sampling sections having different start timings, respectively, and calculating the speed of the motor based on the numbers of pulses of the first signal.

According to an aspect of the present invention, there is provided a motor control apparatus including: a signal generating unit generating a first signal; a sampling unit obtaining the numbers of pulses of the first signal included in a plurality of sampling sections having different start timings, respectively; and a calculating unit calculating a speed of a motor using the numbers of pulses of the first signal obtained with respect to the plurality of sampling sections.

The calculating unit may calculate an average of the numbers of pulses of the first signal obtained with respect to the plurality of sampling sections to calculate the speed of the motor.

The sampling unit may include: a plurality of pulse detectors obtaining the numbers of pulses of the first signal included in the plurality of sampling sections, respectively; and a timing unit controlling operation timings of the plurality of pulse detectors.

The motor control apparatus may further include a controlling unit controlling an operation of the motor based on the speed of the motor calculated by the calculating unit.

The controlling unit may control the operation of the motor by comparing a predetermined reference speed with the speed of the motor calculated by the calculating unit.

At least two sampling sections included in the plurality of sampling sections may have the same period.

According to another aspect of the present invention, there is provided a motor control method including: detecting a first signal; obtaining the numbers of pulses of the first signal included in a plurality of sampling sections having different start timings, respectively; and calculating a speed of a motor based on the numbers of pulses of the first signal obtained with respect to the plurality of sampling sections.

The motor control method may further include controlling an operation of the motor using the speed of the motor.

The operation of the motor may be controlled by comparing a predetermined reference speed with the speed of the motor.

At least two sampling sections included in the plurality of sampling sections may have the same period.

The speed of the motor may be calculated by calculating an average of the numbers of pulses of the first signal obtained with respect to the plurality of sampling sections.

The speed of the motor may be calculated by applying weights to the numbers of pulses of the first signal obtained with respect to the plurality of sampling sections.

The speed of the motor may be calculated by applying different weights to the numbers of pulses of the first signal included in the plurality of sampling sections, respectively, based on at least one of respective periods and respective start timings of the plurality of sampling sections.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram illustrating a motor control apparatus according to an embodiment of the present invention;

FIG. 2 is a block diagram illustrating an example of an internal configuration of a sampling unit shown in FIG. 1;

FIG. 3 is a graph illustrating an operation of a motor control apparatus according to an embodiment of the present invention; and

FIG. 4 is a flowchart illustrating a motor control method according to an embodiment of the present invention.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Throughout the drawings, the same reference numerals will be used to designate the same or like elements.

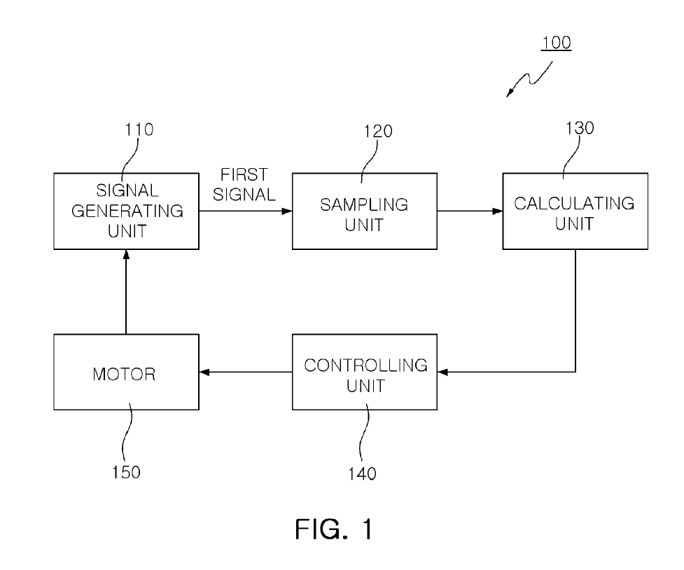

FIG. 1 is a schematic block diagram illustrating a motor control apparatus according to an embodiment of the present invention.

Referring to FIG. 1, a motor control apparatus 100 according to the present embodiment may include a signal generating unit 110, a sampling unit 120, a calculating unit 130, and a controlling unit 140. The controlling unit 140 may control an operation of a motor 150, and the signal generating unit 110 may generate a first signal indicating a position of a rotor of the motor, a speed of the rotor of the motor, and the like using a signal output from the motor.

The first signal output by the signal generating unit 110, a signal determined by the speed, the position, and the like, of the rotor of the motor, may have a plurality of pulses. For example, the faster the rotation speed of the rotor of the motor is, the larger number of pulses the first signal includes. Therefore, the speed of the rotor of the motor may be measured by counting the number of pulses detected in the first signal within a specific time.

In order to accurately detect the speed of the rotor of the motor, a detection time during which the number of pulses of the first signal is detected may be increased by as much as possible. For example, the speed of the rotor of the motor may be more accurately detected in the case of counting the number of pulses appearing in the first signal for 30 μs than in the case of counting the number of pulses appearing in the first signal for 10 μs. However, this method may only be applied in the case in which the speed of the rotor of the motor is constantly maintained without a large change. In the case in which the speed of the rotor of the motor has a large variation width, even though the detection time of the number of pulses of the first signal is increased, it may be difficult to accurately detect the speed of the rotor of the motor.

In the case in which the speed of the rotor of the motor has a large variation width, the number of pulses of the first signal may also be increased or decreased at a large width. That is, in the case in which the speed of the rotor of the motor is increased, the first signal may include the larger number of pulses within the same time, and in the case in which the speed of the rotor of the motor is decreased, the first signal may include the smaller number of pulses within the same time.

In the case that the rotor of the motor is rotated at a very high speed and the speed thereof is then rapidly decreased, the motor may have a slow speed at a specific point in time at which the motor control apparatus 100 is required to detect the speed of the rotor of the motor. In this case, when the detection time during which the number of pulses of the first signal is detected is set to be long in order to accurately measure the speed of the rotor of the motor, even the previous pulses included within the time during which the rotor of the motor has been rotated at a rapid speed are included in the corresponding detection time, such that a significantly large number of pulses may be included in the detection time as compared to a current speed. Therefore, the motor control apparatus 100 determines that the speed of the rotor of the motor is more rapid than an actual operating speed of the rotor of the motor at a current point in time, such that it may not accurately control the operation of the motor.

In order to solve the above-mentioned problem, the present embodiment suggests a method of measuring the speed of the motor 150 by counting the number of pulses of the first signal included in each of a plurality of sampling periods. In particular, when the plurality of sampling periods are set, predetermined delays are set in the respective sampling periods so that start timings of the respective sampling periods are different from each other, whereby accuracy in measuring the speed of the motor may be further increased.

The sampling unit 120 may set N sampling periods having times of T_{C1} to T_{CN}, respectively, and set a delay corresponding to d₁ with respect to a start timing of a second sampling period based on a start timing of a first sampling period. That is, a delay corresponding to dₘ₋₁ may be set in an m-th sampling period (m indicates a natural number smaller than N) to allow the respective sampling periods to be overlapped with each other in a predetermined section.

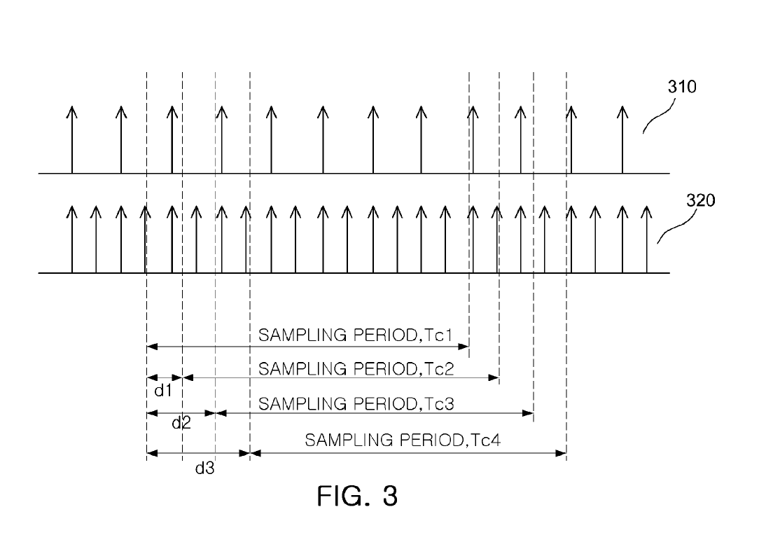

The calculating unit 130 may calculate the speed of the motor 150 using the numbers of pulses of the first signal calculated by the sampling unit 120 with respect to the plurality of sampling periods. In brief, the calculating unit 130 may calculate an average of the numbers of pulses of the first signal included in the respective sampling periods to calculate the speed of the motor 150. This will be described below with reference to FIG. 3.

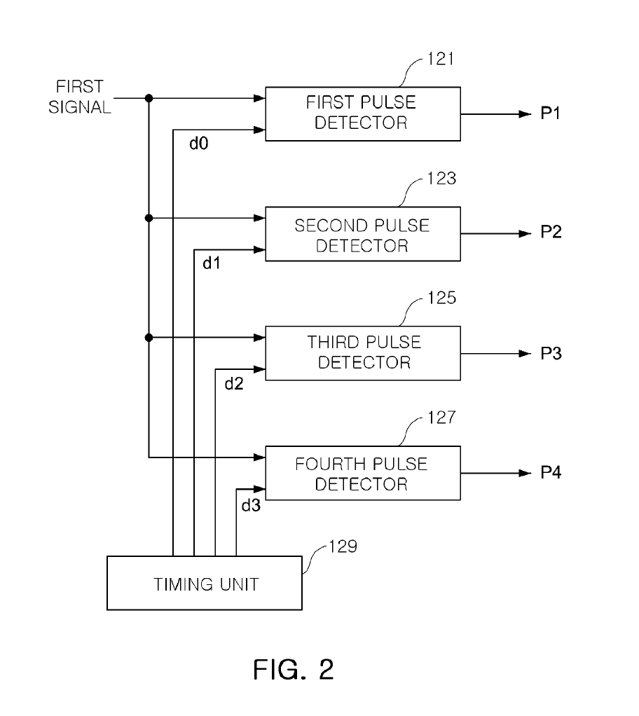

FIG. 2 is a block diagram illustrating an example of an internal configuration of the sampling unit shown in FIG. 1.

Referring to FIG. 2, the sampling unit 120 according to the present embodiment may include a plurality of pulse detectors 121 to 127 receiving the first signal generated by the signal generating unit 110 and counting the number of pulses appearing in the first signal for a predetermined sampling period. Although FIG. 2 shows that the sampling unit 120 includes a total of four pulse detectors 121 to 127, the sampling unit 120 is not necessarily limited thereto. The sampling unit 120 may also include more or less pulse detectors.

The respective pulse detectors 121 to 127 may receive the first signal generated by the signal generating unit 110 and receive delay signals d₀ to d₃ generated by a timing unit 129. The first pulse detector 121 may count the number of pulses appearing in the first signal for a predetermined sampling period. In this case, the first pulse detector may apply a delay of the delay signal d₀ to a start timing of the sampling period. Likewise, the second pulse detector 123 may apply a delay of the delay signal d₁ to a start timing of a corresponding sampling period to count the number of pulses appearing in the first signal for the sampling period.

Here, the sampling periods applied to the respective pulse detectors 121 to 127 may have the same value as each other or different values from each other. However, when a significantly large difference is present among the sampling periods, the speed of the motor 150 may be inaccurately calculated. Accordingly, the respective sampling periods may be set so as not to have a significantly large difference therebetween. For example, a sampling period having the same time may be set to at least two of the four pulse detectors 121 to 127 shown in FIG. 2.

The respective pulse detectors 121 to 127 may start to detect the number of pluses in different start timing, generate the number of pulses included in the respective sampling periods as output signals P₁ to P₄, and send the generated output signals. The output signals P₁ to P₄ may be transferred to the calculating unit 130, and the calculating unit 130 may calculate the speed of the motor 150 using the output signals P₁ to P₄ indicating the number of pulses included in the respective sampling periods.

FIG. 3 is a graph illustrating an operation of a motor control apparatus according to an embodiment of the present invention.

FIG. 3 shows a first signal (a first signal 310 in the first case and a first signal 320 in the second case) detected from the motor 150 in the two cases. It is assumed that the sampling unit 120 includes a total of four pulse detectors 121 to 127 as shown in FIG. 2. Accordingly, the sampling unit 120 may count the number of pulses for each of four sampling periods T_{C1}, T_{C2}, T_{C3}, and T_{C4}. Based on a sampling period T_{C1} having the most rapid start timing, a sampling period T_{C2} may have a delay time corresponding to d₁, a sampling period T_{C3} may have a delay time corresponding to d₂, and a sampling period T_{C4} may have a delay time corresponding to d₃.

Referring to FIG. 3, the numbers of pulses of the first signal 310 and 320 included in the four respective sampling periods T_{C1}, T_{C2}, T_{C3}, and T_{C4} may be given as shown in the following Table 1 with respect to each of the first and second cases.

TABLE 1

| Sampling period | First case | Second case |
|---|---|---|
| T_{C1} | 6 | 12 |
| T_{C2} | 6 | 13 |
| T_{C3} | 7 | 13 |
| T_{C4} | 6 | 12 |

When an arithmetic mean method is applied to the first case, the speed of the motor 150 calculated by the calculating unit 130 is 6.25. In addition, when an arithmetic mean method is applied to the second case, the speed of the motor 150 calculated by the calculating unit 130 is 12.5.

As described above, the speed of the motor 150 is calculated, not by counting the number of pulses of the first signal only once in a single sampling period, but by counting the numbers of pulses of the first signal in a plurality of sampling periods having different start timings as described above, whereby an error may be decreased. Particularly, in the case in which the speed of the motor 150 is relatively slow and a small number of pulses are counted for the sampling period, when the speed of the motor 150 is only calculated by counting the number of pulses once, a large error may occur.

Here, as in the present embodiment, the respective delay times are set so that the plurality of sampling periods have different start timings and the speed of the motor 150 is calculated therefrom, whereby errors may be decreased. Particularly, according to this method, even when the sampling period is not set to be relatively long, the number of pulses of the first signal is counted several times in a short sampling period, whereby the speed of the motor 150 may be accurately calculated without decreasing a calculation speed.

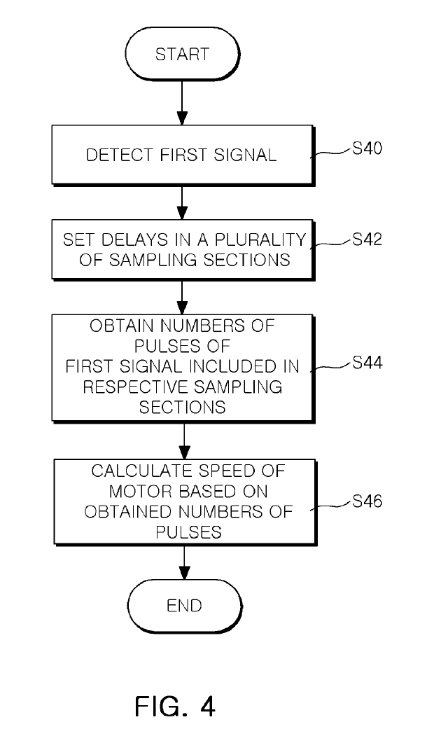

FIG. 4 is a flowchart illustrating a motor control method according to an embodiment of the present invention.

Referring to FIG. 4, the motor control method according to the embodiment of the present invention may start with generating, by the signal generating unit 110, a first signal from the motor 150 (S40). The first signal may include a plurality of pulses, and the number of pulses appearing in the first signal, a period thereof, and the like, may reflect the speed of the motor 150. For example, in the case in which the rotor of the motor 150 is rotated at a rapid speed, a larger number of pulses may appear within the same time, and in the case in which the rotor of the motor 150 is rotated at a relatively slow speed, a smaller number of pulses may appear within the same time.

The first signal generated by the signal generating unit 110 may be transferred to the sampling unit 120, and the timing unit 129 included in the sampling unit 120 may set different delays with respect to respective sampling sections of the plurality of pulse detectors 121 to 127 (S42). Referring to the block diagram shown in FIG. 2, the timing unit 129 may set the delays of d₀ to d₃ with respect to the first to fourth pulse detectors 121 to 127, respectively.

When the delays are set in the respective sampling sections, the plurality of pulse detectors 121 to 127 may obtain the number of pulses of the first signal appearing in the respective sampling sections in which the delays have been set (S44). Referring to the first signal 320 corresponding to the second case in the graph of FIG. 3, twelve pulses are detected in the sampling period T_{C1} in which the delay is not set; thirteen pulses are detected in the sampling period T_{C2} in which the delay corresponding to d1 is set; thirteen pulses are detected in the sampling period T_{C3} in which the delay corresponding to d₂ is set; and twelve pulses are detected in the sampling period T_{C4} in which the delay corresponding to d₃ is set.

The calculating unit 130 may calculate the speed of the motor 150 based on the numbers of pulses obtained in the respective sampling periods in operation S44 (S46). The speed of the motor 150 may be calculated in the simple arithmetic mean scheme as described above or be calculated in a weighted mean scheme in which different weights are applied per each sampling period.

For example, when the first to fourth pulse detectors 121 to 127 obtain the number of pulses, in the case in which the sampling periods applied thereto are different from each other, a higher weight may be applied to the number of pulses obtained in a relatively longer sampling period. Alternatively, in the case in which a portion of the numbers of pulses obtained in the plurality of sampling periods are overlapped and frequently appear, a high weight may be allocated to the corresponding number of pulses.

Referring to the first signal 310 corresponding to the first case in the graph of FIG. 3, six pulses are detected in each of the sampling periods T_{C1}, T_{C2}, and T_{C4}, and seven pulses are detected in the sampling period T_{C3}. That is, since six pulses are detected a total of three times, the speed of the motor 150 may be calculated by allocating a higher weight to the pulses of the first signal 310 detected in the sampling periods T_{C1}, T_{C2}, and T_{C4}.

As set forth above, according to embodiments of the present invention, a first signal reflecting the speed of the motor is detected, and the numbers of pulses of the first signal included in respective sampling sections are detected. In this case, delays are applied to respective start timings of the sampling sections, such that the numbers of pulses of the first signal are detected in different start timings and the speed of the motor is calculated using the numbers of pulses detected as described above. Therefore, the speed of the motor may be accurately detected without significantly increasing the period of the sampling section, and the operation of the motor may be more precisely controlled therefrom.

While the present invention has been shown and described in connection with the embodiments, it will be apparent to those skilled in the art that modifications and variations can be made without departing from the spirit and scope of the invention as defined by the appended claims.

What is claimed is:

1. A motor control apparatus comprising:
a signal generating unit generating a first signal;
a sampling unit obtaining the numbers of pulses of the first signal included in a plurality of sampling sections having different start timings, respectively; and
a calculating unit calculating a speed of a motor using the numbers of pulses of the first signal obtained with respect to the plurality of sampling sections, respectively.

2. The motor control apparatus of claim 1, wherein the calculating unit calculates an average of the numbers of pulses of the first signal obtained with respect to the plurality of sampling sections to calculate the speed of the motor.

3. The motor control apparatus of claim 1, wherein the sampling unit includes:
a plurality of pulse detectors obtaining the numbers of pulses of the first signal included in the plurality of sampling sections, respectively; and
a timing unit controlling operation timings of the plurality of pulse detectors.

4. The motor control apparatus of claim 1, further comprising a controlling unit controlling an operation of the motor based on the speed of the motor calculated by the calculating unit.

5. The motor control apparatus of claim 4, wherein the controlling unit controls the operation of the motor by comparing a predetermined reference speed with the speed of the motor calculated by the calculating unit.

6. The motor control apparatus of claim 1, wherein at least two sampling sections included in the plurality of sampling sections have the same period.

7. A motor control method comprising:
detecting a first signal;
obtaining the numbers of pulses of the first signal included in a plurality of sampling sections having different start timings, respectively; and
calculating a speed of a motor based on the numbers of pulses of the first signal obtained with respect to the plurality of sampling sections.

8. The motor control method of claim 7, further comprising controlling an operation of the motor using the speed of the motor.

9. The motor control method of claim 8, wherein the operation of the motor is controlled by comparing a predetermined reference speed with the speed of the motor.

10. The motor control method of claim 7, wherein at least two sampling sections included in the plurality of sampling sections have the same period.

11. The motor control method of claim 7, wherein the speed of the motor is calculated by calculating an average of the numbers of pulses of the first signal obtained with respect to the plurality of sampling sections.

12. The motor control method of claim 11, wherein the speed of the motor is calculated by applying weights to the numbers of pulses of the first signal obtained with respect to the plurality of sampling sections.

13. The motor control method of claim 12, wherein the speed of the motor is calculated by applying different weights to the numbers of pulses of the first signal included in the plurality of sampling sections, respectively, based on at least one of respective periods and respective start timings of the plurality of sampling sections.
